(19) United States
(12) Patent Application Publication
(10) Pub. No.: US 2008/0243658 A1
(43) Pub. Date: Oct. 2, 2008

(54) HOUSING DEVELOPMENT METHOD AND SYSTEM

(76) Inventors: Charles P. Clegg, Plano, TX (US); Harry J. James, Garland, TX (US); Lynn Klinefelter, Wylie, TX (US)

Correspondence Address: Michael L. Diaz;Michael L. Diaz, P.C., Suite 200, 555 Republic Drive, Plano, TX, 75074, US

(21) Appl. No.: 11/692,355

(22) Filed: Mar. 28, 2007

(51) Int. Cl. G06Q 40/00

(52) U.S. Cl. 705/35

(57) ABSTRACT

A system and method for developing and building homes combining energy efficient and environmentally friendly or “green” housing technologies with innovative financial programs for the builder and buyer. The system includes a home building company constructing a plurality of homes located within the home development. Each home is developed and operated by utilizing energy efficient and “green” housing technologies. A financing scheme for financing the construction of the plurality of homes by the home building company and the purchase of each home by the purchaser is also provided. The financing scheme includes a Public Improvement District (PID) assessment program to finance the home development.

### BACKGROUND OF THE INVENTION

1. Field of the Invention

This invention relates to housing development. Specifically, and not by way of limitation, the present invention relates to a system and method for developing and building homes combining energy efficient and environmentally friendly housing technologies with innovative financial programs for the builder and buyer.

2. Description of the Related Art

Population growth has resulted in an explosion of new housing developments. As of the end of 2005, according to the US Census Bureau, that growth rate was 1.3% per year in the United States (with a total currently estimated to be slightly over 300,000,000). It represents the primary reason that national new housing starts are currently running approximately 1,380,000 units per year as of December, 2006. Texas is one of the prime areas supporting this new growth with 162,480 new housing starts in 2006.

At the same time, this unprecedented growth has been recognized as a major factor in bringing environmental issues to public awareness, particularly in new home construction. Professionals charged with building communities such as developers, builders, architects and city officials have been looking for ways to create not only housing but entire neighborhoods that put people, and their environment, first. Natural resources are finite and new technologies are now required to modify the ever increasing demand on these resources and reverse or minimize the negative environmental impact of our past and present growth rates. However, currently it is extremely difficult to provide affordable homes to the general public that are environmentally friendly and energy efficient.

In addition, municipalities and other government entities utilize public improvement districts (PIDs) to fund large community related projects. However, currently no housing developments utilize these PIDs to fund private housing development projects. A system and method are needed which provides affordable housing which is energy efficient, environmentally friendly and financially profitable to developments.

Although there are no known prior art teachings of an system or method such as that disclosed herein, prior art references that discuss subject matter that bears some relation to matters discussed herein are U.S. Patent Application Publication Number 2005/0137965 to Fisk (Fisk), U.S. Patent Application Publication Number 2006/0080246 to Wyckoff (Wyckoff), U.S. Patent Application Publication Number 2006/0143103 to Denne et al. (Denne), and U.S. Patent Application Publication Number 2006/0271458 to Arnold, Ill. et al. (Arnold).

Fisk discloses a method of constructing and financing a home. However, Fisk does not teach or suggest utilizing PIDs in conjunction with building environmentally friendly and energy efficient homes. Fisk merely discloses constructing a home using attic trusses which decreases the cost of building the home.

Wyckoff discloses a program for encouraging homebuyers to purchase efficient HVAC equipment at the time they purchase an existing home However, Wyckoff does not teach or suggest utilizing PIDs or building environmentally friendly and energy efficient homes.

Denne discloses a method of financing environmentally focused projects. However, Denne also does not teach or suggest utilizing PIDs in combination with building environmentally friendly and energy efficient homes. Rather, Denne merely discloses a financing method for environmentally focused projects and not the construction of homes.

Arnold discloses a method of financing a real estate purchase. However, Arnold does not teach or suggest utilizing PIDs or building environmentally friendly and energy efficient homes.

Thus, it would be advantageous to have a system and method which enables a home owner to purchase a home with affordable financing which utilizes the latest environmentally friendly and energy efficient techniques in building and maintaining a home. It is an object of the present invention to provide such a system and method.

### SUMMARY OF THE INVENTION

In one aspect, the present invention is a system for developing and building homes. The system includes a home building company constructing a plurality of homes located within the home development. Each home is developed and operated by utilizing economically viable energy efficient and environmentally friendly housing technologies. A financing scheme for financing the construction of the plurality of homes by the home building company and the purchase of each home by the purchaser is also provided. The financing scheme includes a Public Improvement District (PID) assessment program to finance the home development.

In another aspect, the present invention is a method of developing a home development having a plurality of homes. The method begins by implementing a financing scheme for financing the construction of the plurality of homes by the home building company and purchase of each home by a home purchaser. The financing scheme includes a Public Improvement District (PID) assessment program to finance the home development. The method also includes constructing a plurality of homes constructed by a home building company and purchasing by the home purchaser of a home within the home development.

In still another aspect, the present invention is a method of developing, building and marketing homes to a plurality of purchasers. The method begins by determining projects for use within a home development containing the homes. Next, a Public Improvement District (PID) assessment program is implemented to fund the determined projects within the home development. Homes are then constructed within the home development.

### BRIEF DESCRIPTION OF THE DRAWINGS

FIG. 1 is a simplified block diagram of the entities of a home development system;

FIG. 2 is a simplified block diagram of the major components of the home development system in the preferred embodiment of the present invention; and

FIG. 3 is a flow chart outlining the steps for developing, building and marketing affordable energy efficient and environmentally friendly homes according to the teachings of the present invention.

### DESCRIPTION OF THE INVENTION

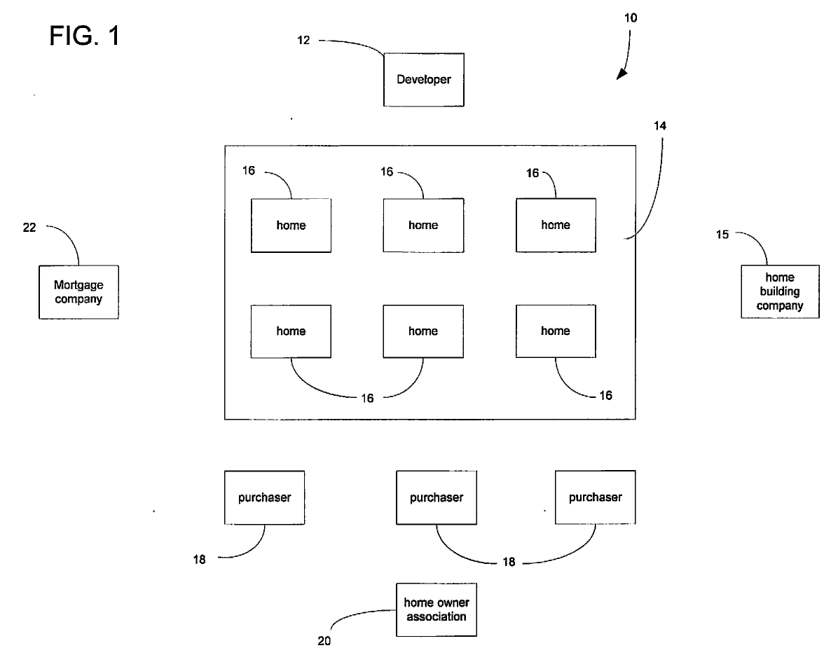

The present invention relates to a system and method for developing and building homes combining energy efficient and environmentally friendly housing technologies with innovative financial programs for the builder and buyer. FIG. 1 is a simplified block diagram of the entities of a home development system 10. The home development system 10 includes a developer 12 of a home development 14. One or more home building companies 15 build a plurality of homes 16 within the home development 14. Each home 16 is purchased by a home purchaser 18. The home purchasers preferably belong to a home owner's association 20 representing the collective interests of the home purchases. The home owner's association may be any entity representing the home purchasers 18 as a group. In addition, a mortgage company 22 may provide a loan to the home purchaser 18 to buy the home 16.

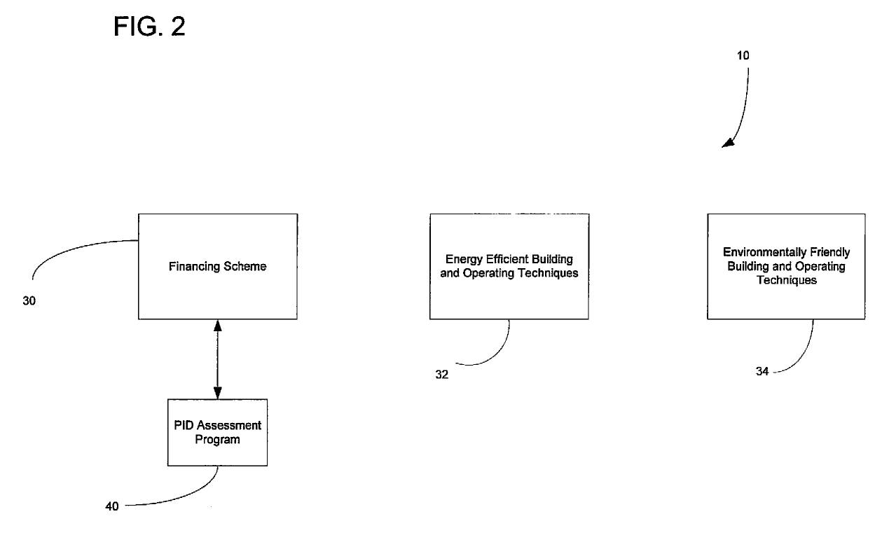

FIG. 2 is a simplified block diagram of the major components of the home development system 10 in the preferred embodiment of the present invention. The home development system 10 employs several major components to provide affordable energy efficient and environmentally friendly housing to the home purchasers 18. The home development system utilizes an innovative financing scheme 30 coupled with energy efficient building and operating techniques 32 and environmentally friendly building and operating techniques 34. In the present invention, an energy efficient home is one which employs energy saving measures, discussed below, for operating and living in the home. Additionally, an environmentally friendly home employs environmentally friendly measures for constructing, operating and living in each home. All the components are interconnected to provide an affordable home 16 to the home purchaser 18.

To provide affording housing utilizing these housing technologies, an important component of the present invention is the financing scheme 30 provided to the home purchaser 18. Public Improvement Districts (PIDs) have been used by municipalities and counties for several years to pay for the cost of capital improvements or maintenance for improvements that benefit a specific number of taxpayers located within a defined district. In its most basic form, it is a method of beneficial financing so parties or taxpayers within the specified district are responsible for payment of capital reimbursement or maintenance cost of public improvements. The method of collection is through a levy by the local municipality of a special tax or assessmerit on the taxable property within the district. As a result, these are called special tax or special assessment based districts. For example, when a city needs to upgrade the sewer and waste water facilities within a specified area of the city, the city forms a PID that includes only those tax parcels that would benefit from the installation of the improved waste water facilities. The city establishes an additional tax that is collected each year on each tax parcel in the district until the improvements are paid and the city is reimbursed.

Currently, PID districts can also be formed by the petition of a majority of the land owners within the proposed district. Consequently, land owners desiring to install public improvements on their property may petition the local municipality or county and request the formation of a district and then request that the municipality levy a special tax or assessment on the tax parcels within the district in order to obtain reimbursement for public improvements installed that directly benefited the tax parcels in the district.

As discussed above, this reimbursement may take the form of a special ad valorum tax that is levied on each tax parcel. Alternatively, the reimbursement may be in the form of an assessment. The key distinction is that if it is a tax, then a sufficient taxable property in the district is required to meet the tax obligation. If a tax is imposed in anticipation of new construction, and that construction does not occur, then there could be an unfair tax burden on those properties that do have taxable value. Currently, this has been a problem with a number of tax based districts whereby taxes are imposed and building does not occur resulting in a tax rate on those properties that could be taxed being increased unreasonably in order to meet the reimbursement obligation.

The second method of reimbursement of these existing PIDs is assessment-based levies. These levies are structured and applied against each tax parcel regardless of property value on the tax parcel and are levied based on the benefits that each tax parcel received from the improvements as approved by bond underwriters. In essence, this is a beneficial based assessment. For example, if the developer is funding local streets and one lot had twice the front footage of another lot, then the larger lot would bear twice the assessment levy of the smaller lot for the cost of street improvements. The more important advantage of assessment levies is that each levy is separate and distinct from any other levy which can be prepaid in whole or in part at any time, can never be increased, and the non-payment of a levy by one tax parcel has no effect on the levy on any other tax parcel. This is a critical difference from tax based districts where the tax burden within the district is joint and several and a default, non-payment, or lack of development of ad valorum values transfers the tax impact to those properties that can pay.

Another advantage to assessments is a payment can be defined since the assessment is levied when the total value of the improvements to be installed is known or the improvements have been installed. Since the assessment is fixed and can be amortized over a period of time, these assessments can be used as collateral for bond financing to provide the funds to pay for the improvements. The bond buyers buy the bonds knowing that the value of the land after the improvements have been installed will be greater than the amount of the assessment and therefore provide good collateral for the bond buyer.

This ability to use the assessments as collateral is another sharp distinction from tax based districts. In a tax based district, it would not be possible to sell bonds until it is known that a sufficient ad valorum value in the district is attained so it would be reasonable that all properties could pay an ad valorum tax sufficient to pay for the cost of bond retirement. Thus, most tax districts, such as in Municipal Utility Districts and Fresh Water Districts, have bonds that are not sold until a certain amount of residential or commercial construction has been completed.

With assessment based districts, the bonds may be sold to finance the improvements as long as it is certain that the value of the developed land can support the collateral base for the assessment. Historically, many developers would use PID assessments only for reimbursement. The developers would install the improvements and then levy the assessment so they would be repaid over a period of time for the cost of those improvements.

The present invention utilizes these PID assessment programs 40 (see FIG. 2) to fund various projects within a housing development. Bonds may be sold in reliance on the assessments with no liability to a municipality and the bond proceeds used to fund the improvements. Thus, tax-exempt assessment based bond financing is utilized for the developer 12 to fund the projects within the home development 14. Further, since the assessments run with the land, each tax parcel may also be sold with assumption of the assessment or either the seller or the buyer may alternatively pay all or part of the assessment off at any time (or at the time of sale), and when fully paid, it would no longer be a factor for that specific tax parcel. If prepaid, then a corresponding amount of bonds would also be retired.

In the present invention, the home building company 15 purchases its lot inventory from the developer 12 that utilizes a privately financed Public Improvement District (PID) assessment program 40 to fund the majority of the development hard cost of a given project as well as certain soft costs associated with the improvements such as engineering, construction management and capitalized interest charges. As a result, the majority (usually 70% to 75%) of the normal lot purchase price is preferably passed through the lot sales process as an underlying assessment on each lot. The underlying assessment is then fully amortized over a specified period of time, such as 30 years and is assumed by both the home building company 15 and the subsequent new home purchaser 18. This can also be treated by the mortgage company 22 as a down payment, i.e., the “pre-financed” down payment. Thus, the financing of the home, i.e., the assessment, is not recognized as senior debt on the property, but as an assessment only. For the purpose of mortgage qualification and loan to appraisal value, the assessment is recognized as an annual tax charge the home purchaser 18 must pay in consideration of qualification.

By utilizing the financial funding scheme 30 of the present invention, the home building company 15 may purchase lots by assuming the underlying assessment and paying cash for the remaining balance (about 25% to 30%) of the normal wholesale builder lot price for that subdivision. This new lot acquisition program may provide a basic lot inventory to the home building company 15 at a much higher value than its cash investment. For example, the home building company may only have to finance (with a 1^{st} lien) the difference between the lot sales price and the underlying total PID assessment. The initial lot acquisition by the home building company 15 may require a “Letter Of Credit” on behalf of the home building company payable to both the developer 12 and a bond underwriter (not shown in FIG. 1) in order to maintain an approximate 50% “Bond to Risk” ratio. However, the letter of credit will automatically terminate (on a prorata basis) as and when each new home 16 receives a certificate of occupancy which establishes a higher total property value, thereby bringing the “bond to risk” ratio back to an acceptable percentage. Additionally, the 30 year fully amortized assessment may bear interest at a much lower percentage rate than standard lot financing because the bonds sold are tax exempt.

Utilizing the PID assessment program 40, a standard home purchase mortgage may now include all of the standard cash closing costs and still be well under 100% of the purchase price and/or appraised value. Coupled with permanent standard end loans from major mortgage companies, this unique PID assessment program 40 enables the home building company 15 to market all of its new homes with a legitimate “no cash down payment” promotion. This results in a lower blended total mortgage payment for the new home purchaser 18.

“Energy Efficient” is a designation that at times may require certification by a licensed “Energy Rater” (Rater). A rater must represent an acknowledged “Provider”. These rating designations are generally produced using the HERS (Home Energy Rating System) rating (point) scale, and are recognized by Federal and State Tax law to certify homes for tax incentives. Their ratings are also recognized by all of the major “green” organizations. In addition, new recognized designations are also being developed by the National Association of Home Builders (NAHB).

In the preferred embodiment of the present invention, the home building company 15 utilizes the energy efficient building and operating techniques 32 by incorporating a wide variety of state-of-the-art green building products starting with the latest technology in steel and/or specially treated wood and/or concrete framing systems. Coupled with the latest high R-value construction techniques, non-emissive interior products, air handlers, etc., the addition of alternative electric generating systems for each new home preferably allows these new green homes to also qualify as “Energy Efficient” homes.

With economically viable “green lot” inventory assured by the home building company 15, the home building company provides state-of-the-art economically viable green building products starting with the latest technology in steel, specially treated wood, and concrete framing systems. Additionally, the latest high R-value construction techniques, non-emissive interior products, air handlers, etc., may be used to construct the homes 16. The addition of alternative electric generating systems on each home is preferably utilized to allow all of these new “green” homes to qualify for much higher than normal green energy efficient ratings as certified by a recognized rater, the NAHB, or another organization. When using the PID assessment program discussed above, permanent end loans may be provided by mortgage companies 22 so as to enable this home building company to market all of these state-of-the-art energy efficient new homes 16 with a legitimate “no cash down payment” program. Thus, the present invention provides an affordable environmentally-friendly and energy efficient home to the home purchaser 18 which was previously not available to the general public.

Currently there are serious potable water shortages within many regions of the United States. In the preferred embodiment of the present invention, water conservation measures are incorporated in building and operating the new homes. To address this specific major issue, non-potable water is preferably drawn from shallow areas of the local water table using cost effective water wells coupled with drip line irrigation systems (to minimize evaporation) in all, or most, of its new subdivisions. While the initial cost of this method is relatively high on an individual home by home basis, a developer installing such a system into the entire home development 14 is able to affect a reasonable per lot cost.

In the preferred embodiment of the present invention, the developer 12 digs wells, installs the required pumps and pressure tank(s) and runs a non-potable water main in the standard subdivision utility easements with laterals and a valve to each lot. The balance of the typical installation from that point would be the responsibility of the home building company 15 who purchases the lots. Preferably, the home owners' association 20 would eventually have ownership and maintenance responsibility for the finished system up to the individual home owner's lot line and would also set policies for use of the system by the homeowners (including drip line requirements). The cost of operations and maintenance would preferably be included in the dues paid by the home purchases 18 to the home owners' association 20. Thus, the present invention provides a program that is cost effective, which provides a year round efficient landscape irrigation system for an entire subdivision that also creates major cutbacks in the standard current use of potable water per single family home.

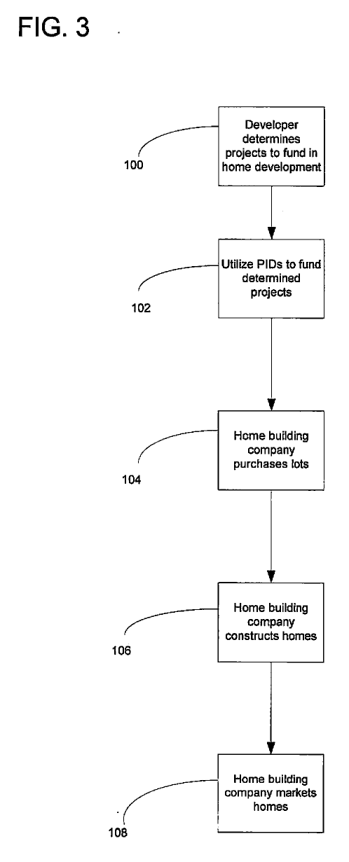

FIG. 3 is a flow chart outlining the steps for developing, building and marketing affordable energy efficient and environmentally friendly homes according to the teachings of the present invention. With reference to FIGS. 1-3, the steps of the method will now be explained. The method begins with step 100 where the developer 12 determines projects to fund in the home development 14. Specifically, for high cost capital expenditures, the developer determines if the innovative financing scheme 30 is desirable for a particular project. Next, in step 102, the developer 12, or alternatively the home building company 15 utilizes PIDs to fund the determined projects of step 100. The present invention utilizes these PID assessment programs 40 (see FIG. 2) to fund the determined projects within a housing development. Bonds may be sold in reliance on the assessments with no liability to a municipality and the bond proceeds used to fund the improvements. Thus, tax-exempt assessment based bond financing is utilized for the developer 12 to fund the projects within the home development 14. Furthermore, since the assessments run with the land, each tax parcel may also be sold with assumption of the assessment or either the seller or the buyer may alternatively pay all or part of the assessment off at any time (or at the time of sale), and when fully paid, may no longer be a factor for that specific tax parcel. If prepaid, then a corresponding amount of bonds may also be retired.

The method then moves to step 104 where the home building company 15 purchases its lot inventory from the developer 12 that utilizes the privately financed PID assessment program 40 to fund substantially all of the development hard cost of a given project as well as certain soft costs associated with the improvements such as engineering, construction management and capitalized interest charges. Some projects, such as the potable water system may not qualify for PID financing. The underlying assessment is then fully amortized over a specified period of time, such as 30 years and is assumed by both the home building company 15 and the subsequent new home purchaser 18. By utilizing the financial funding scheme 30 of the present invention, the home building company 15 may purchase lots by assuming the underlying assessment and paying cash for the remaining balance (about 25% to 30%) of the normal wholesale builder lot price for that subdivision. This new lot acquisition program may provide a basic lot inventory to the home building company 15 at a much higher value than its cash investment.

Next, in step 106, the home building company 15 constructs economically viable environmentally friendly energy efficient homes. In the preferred embodiment of the present invention, the home building company 15 utilizes energy efficient building and operating techniques 32 by incorporating a wide variety of state-of-the-art green building products starting with the latest technology in steel and/or concrete and/or specially treated wood framing systems. Coupled with the latest high R-value construction techniques, non-emissive interior products, air handlers, etc., the addition of alternative electric generating systems for each new home preferably allows these new green homes to also qualify as “Energy Efficient” homes. In addition, the home building company 15 utilizes environmentally friendly building and operating techniques 34. The addition of alternative electric generating systems on each home is preferably utilized to allow these new “green” homes to qualify for higher than normal green energy efficient ratings as certified by a recognized rater, the NAHB, or another association.

The home building company (or developer) may optionally provide water conservation techniques. In the preferred embodiment of the present invention, the developer 12 digs wells, installs the required pumps and pressure tank(s) and runs a non-potable water main in the standard subdivision utility easements with laterals and a valve to each lot. The balance of the typical installation from that point may be the responsibility of the home building company 15 who purchases the lots. Preferably, the home owners' association 20 eventually obtains ownership and maintenance responsibilities for the finished system up to the individual home owner's lot line and preferably sets policies for use of the system by the homeowners (including drip line requirements). The cost of operations and maintenance would be included in the dues paid by the home purchases 18 to the home owners' association 20. Thus, the present invention provides a program that is cost effective, which provides a year round efficient landscape irrigation system for an entire subdivision that also creates major cutbacks in the standard current use of potable water per single family home.

The method then moves to step 108 where the home building company 15 markets the affordable homes to the public. When using the PID assessment program discussed above, permanent end loans may be provided by mortgage companies so as to enable the home building company to market all of these state-of-the-art energy efficient new homes 16 with a legitimate “no cash down payment” program. This “no cash down payment” program coupled with the construction of energy efficient and environmentally friendly homes is easily marketable to a large segment of the general public.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A system for developing a home development, the system comprising:
a home building company;
a plurality of homes constructed by the home building company and located within the home development, each home purchased by a purchaser; and
a financing scheme for financing the construction of the plurality of homes by the home building company and purchase of each home by the purchaser, wherein the financing scheme includes a Public Improvement District (PID) assessment program to finance the home development.

2. The system for developing a home development of claim 1 wherein the plurality of homes are constructed as energy efficient homes by employing energy saving measures for operating and living in each home.

3. The system for developing a home development of claim 1 wherein each home is a home employing environmentally friendly measures for constructing, operating and living in each home.

4. The system for developing a home development of claim 1 wherein the home development employs water conservation measures to minimize the usage of potable water by the plurality of homes.

5. The system for developing a home development of claim 4 wherein the conservation measures include drawing water from shallow areas of the local water table using cost effective water wells coupled with drip line irrigation systems to minimize evaporation.

6. The system for developing a home development of claim 1 wherein the financing scheme provides a mortgage without a cash down payment to the purchaser.

7. The system for developing a home development of claim 1 wherein the financing scheme is utilized to fund high expenditure projects in the home development

8. The system for developing a home development of claim 1 wherein the PID assessment program finances at least a portion of hard costs of a specified project within the home development.

9. The system for developing a home development of claim 1 wherein assessments utilized by the PID assessment program are collateral for bond financing to provide the funds to pay for specified soft and hard costs in constructing the home development.

10. A method of developing, building and marketing homes to a plurality of purchasers, the method comprising the steps of:
determining projects for use within a home development containing the homes;
implementing a Public Improvement District (PID) assessment program to fund the determined projects within the home development; and
constructing the homes for the home development.

11. The method of developing, building and marketing homes to a plurality of purchasers of claim 10 further comprising the step of marketing the homes with no down payment required for purchasing the home.

12. The method of developing, building and marketing homes to a plurality of purchasers of claim 10 wherein the homes are rated by a designated certification as energy efficient homes.

13. The method of developing, building and marketing homes to a plurality of purchasers of claim 10 wherein each home is an environmentally friendly home employing environmentally friendly measures for constructing, operating and living in each home.

14. The method of developing, building and marketing homes to a plurality of purchasers of claim 10 further comprising the step of purchasing land lots for constructing the homes within the home development utilizing the PID assessment program to fund at least a portion of the purchase of the land lots.

15. The method of developing, building and marketing homes to a plurality of purchasers of claim 10 further comprising the step of employing water conservation measures to minimize the usage of potable water by the homes.

16. A method of developing a home development having a plurality of homes, the method comprising the steps of:
implementing a financing scheme for financing the construction of the plurality of homes by the home building company and purchase of each home by a home purchaser, wherein the financing scheme includes a Public Improvement District (PID) assessment program to finance at least a portion of the home development or home;
constructing a plurality of homes constructed by a home building company, the plurality of homes located within the home development; and
purchasing by the home purchaser of a home within the home development.

17. The method of developing a home development of claim 16 wherein the plurality of homes are homes employing energy efficient measure for operating and living in the homes.

18. The method of developing a home development of claim 16 wherein each home is an environmentally friendly home employing environmentally friendly measures for constructing, operating and living in each home.

19. The method of developing a home development of claim 17 wherein the home development employs water conservation measures to minimize the usage of potable water by the plurality of homes.
